(19) United States
(12) Patent Application Publication
(10) Pub. No.: US 2025/0192385 A1
(43) Pub. Date: Jun. 12, 2025

(54) STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/953,324

(22) Filed: Nov. 20, 2024

(30) Foreign Application Priority Data
Dec. 11, 2023 (JP) 2023-208239

(51) Int. Cl. H01M 50/533; H01M 10/04; H01M 50/107; H01M 50/538

(52) U.S. Cl. CPC H01M 50/533; H01M 10/0431; H01M 50/107; H01M 50/538

(57) ABSTRACT

A storage cell includes a wound electrode body and a cell case that accommodates the wound electrode body. The wound electrode body includes an electrode plate and a tab lead. The electrode plate includes a current collector foil and an electrode material layer. The electrode material layer covers a part of the current collector foil. The tab lead includes a curved portion and an extending portion. The curved portion is provided on an uncoated portion of the current collector foil that is not coated with the electrode material layer, and extends to be curved along a winding direction of the wound electrode body. The extending portion extends from the curved portion and protrudes to one side of the current collector foil in an axial direction of the wound electrode body. The curved portion includes a groove portion extending along the axial direction.

### CROSS-REFERENCE TO RELATED APPLICATION

This application claims priority to Japanese Patent Application No. 2023-208239 filed on Dec. 11, 2023, incorporated herein by reference in its entirety.

### BACKGROUND

### 1. Technical Field

The disclosure relates to a storage cell.

### 2. Description of Related Art

Japanese Patent No. 3203517 (JP 3203517 B) discloses a battery as a conventional storage cell. The battery includes a wound electrode body, a first electrode lead, and a battery can in which the wound electrode body is accommodated. The first electrode lead is provided to be connected to a first band-shaped electrode at a winding end portion on the outer peripheral side of the wound electrode body. A second electrode lead is provided to be connected to a second band-shaped electrode at a winding end portion on the inner peripheral side of the wound electrode body.

### SUMMARY

In recent years, there has been a desire for increasing in size of storage cells. When a storage cell is made larger in size, current flowing through a wound electrode body increases. For this reason, it is conceivable to increase the length of a tab lead (electrode lead) in a winding direction of the wound electrode body, which causes an expectation of reducing the electrical resistance of the tab lead. However, increase in size of the tab lead also causes increase in stress to be applied to a portion of the tab lead which is curved along the winding direction of the wound electrode body.

The present disclosure has been made in view of the above problem, and has an object to provide a storage cell that can reduce stress on a tab lead.

A storage cell according to an aspect of the present disclosure comprises a wound electrode body, and a cell case that accommodates the wound electrode body. The wound electrode body includes an electrode plate and a tab lead. The electrode plate includes a current collector foil, and an electrode material layer. The electrode material layer covers a part of the current collector foil. The tab lead includes a curved portion and an extending portion. The curved portion is provided on an uncoated portion of the current collector foil that is not coated with the electrode material layer, and extends so as to be curved along a winding direction of the wound electrode body. The extending portion extends from the curved portion, and protrudes to one side of the current collector foil in an axial direction of the wound electrode body. The curved portion includes a groove portion extending along the axial direction.

According to the above configuration, the curved portion is easily bent at the groove portion. Therefore, even when the tab lead is made larger in the winding direction, the curved portion can extend in a direction closer to the winding direction. As a result, stress on the tab lead can be reduced.

In the storage cell according to the aspect of the present disclosure, the curved portion may include a plurality of groove portions arranged side by side in the winding direction.

According to the above configuration, the curved portion can extend in a direction which is further closer to the winding direction. As a result, stress on the tab lead can be further reduced.

In the storage cell according to the aspect of the present disclosure, the extending portion may have a root portion. The root portion is a portion connected to the curved portion. The root portion is arranged so as not to be lined up with the groove portion in the axial direction.

According to the above configuration, it is possible to restrain the extending portion from bending in an unintended manner due to bending of the curved portion in the groove portion.

In the storage cell according to the aspect of the present disclosure, the tab lead may have a plurality of extending portions arranged side by side in the winding direction. Each of the plurality of extending portions has a root portion that is a portion connected to the curved portion. The root portion of each of the plurality of extending portions is arranged so as not to be lined up with the groove portion in the axial direction.

According to the above configuration, by providing the plurality of extending portions, heat generating portions of the tab lead can be dispersed. Furthermore, by arranging the plurality of extending portions in a manner as described above, it is possible to restrain the plurality of extending portions from bending in an unintended manner.

In the storage cell according to the aspect of the present disclosure, the tab lead may have a plurality of extending portions arranged side by side in the winding direction. Each of the plurality of extending portions has a root portion that is a portion connected to the curved portion. The root portion of each of the plurality of extending portions is arranged so as not to be lined up with any of the plurality of groove portions in the axial direction. The respective root portions of the plurality of extending portions are spaced apart from one another in the winding direction.

According to the above configuration, by providing the plurality of extending portions, the heat generating portions of the tab lead can be dispersed. By arranging the plurality of extending portions in a manner as described above, it is possible to restrain the plurality of extending portions from bending in an unintended manner. Furthermore, since the root portions are spaced apart from one another, the plurality of extending portions can easily bend toward the center in a radial direction at the root portions. Therefore, it is possible to easily adjust the extending directions of the plurality of extending portions.

According to the present disclosure, it is possible to reduce stress on the tab lead.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a storage cell according to an embodiment of the present disclosure;

FIG. 2 is a schematic plan view of a portion of a wound electrode body as viewed from one side in an axial direction of the wound electrode body;

FIG. 3 is a schematic diagram showing a positive electrode plate and a positive electrode tab lead in a state where they are unwound and extended in a planar shape;

FIG. 4 is a schematic plan view of a portion of the wound electrode body as viewed from the other side in the axial direction of the wound electrode body; and

FIG. 5 is a schematic diagram showing a negative electrode plate and a negative electrode tab lead in a state where they are unwound and extended in a planar shape.

### DETAILED DESCRIPTION OF EMBODIMENTS

An embodiment of the present disclosure will be described in detail below with reference to the drawings. Furthermore, the same reference signs are appended to the same or corresponding portions in the figures, and the description on the portions will not be repeated.

A storage cell according to an embodiment of the present disclosure which will be described below is, for example, a lithium ion battery to be mounted on a vehicle. Note that intended use and type of the storage cell are not limited to the above example.

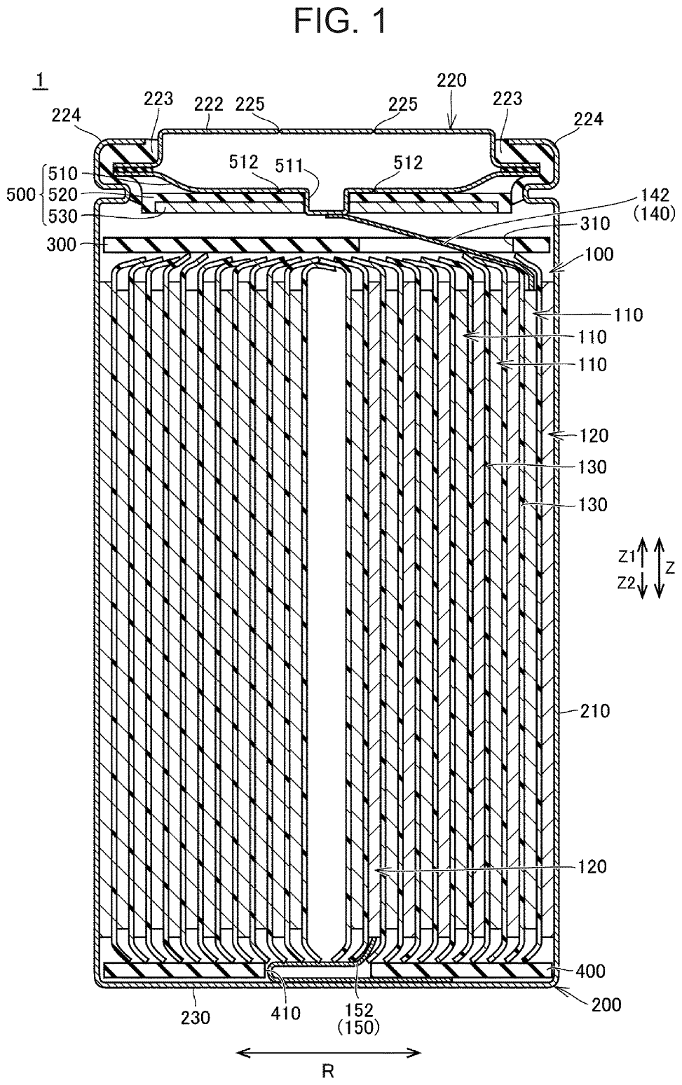

FIG. 1 is a sectional view showing the storage cell according to the embodiment of the present disclosure. FIG. 1 shows an overall configuration of the storage cell 1 according to the embodiment of the present disclosure.

As shown in FIG. 1, the storage cell 1 includes a wound electrode body 100 and a cell case 200.

The wound electrode body 100 includes a positive electrode plate 110, a negative electrode plate 120, a separator 130, a positive electrode tab lead 140, and a negative electrode tab lead 150. The wound electrode body 100 is configured to include an electrode plate group in which the positive electrode plate 110 and the negative electrode plate 120 are wound with the separator 130 interposed therebetween.

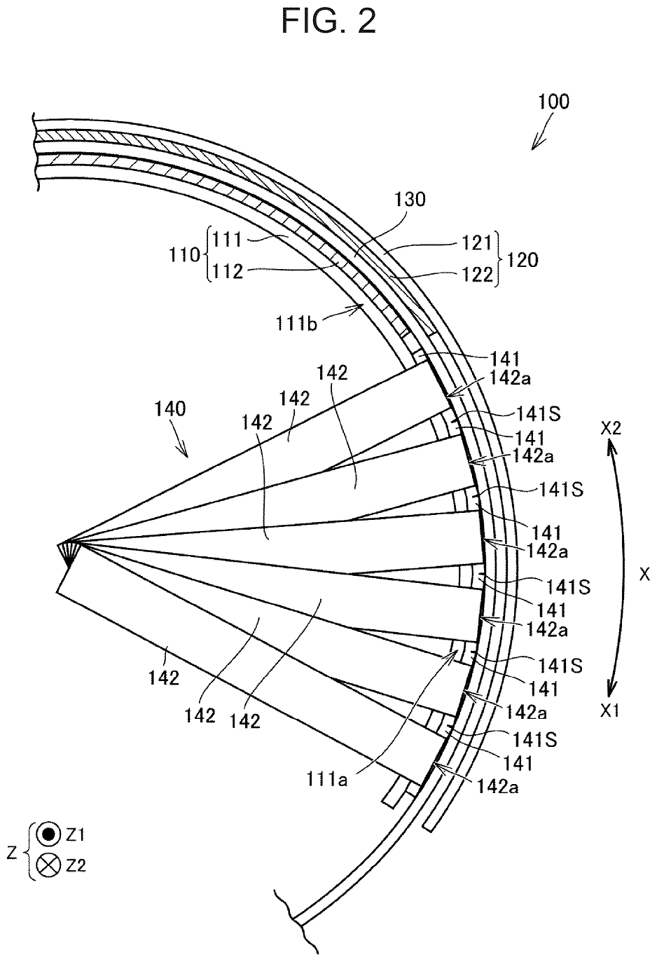

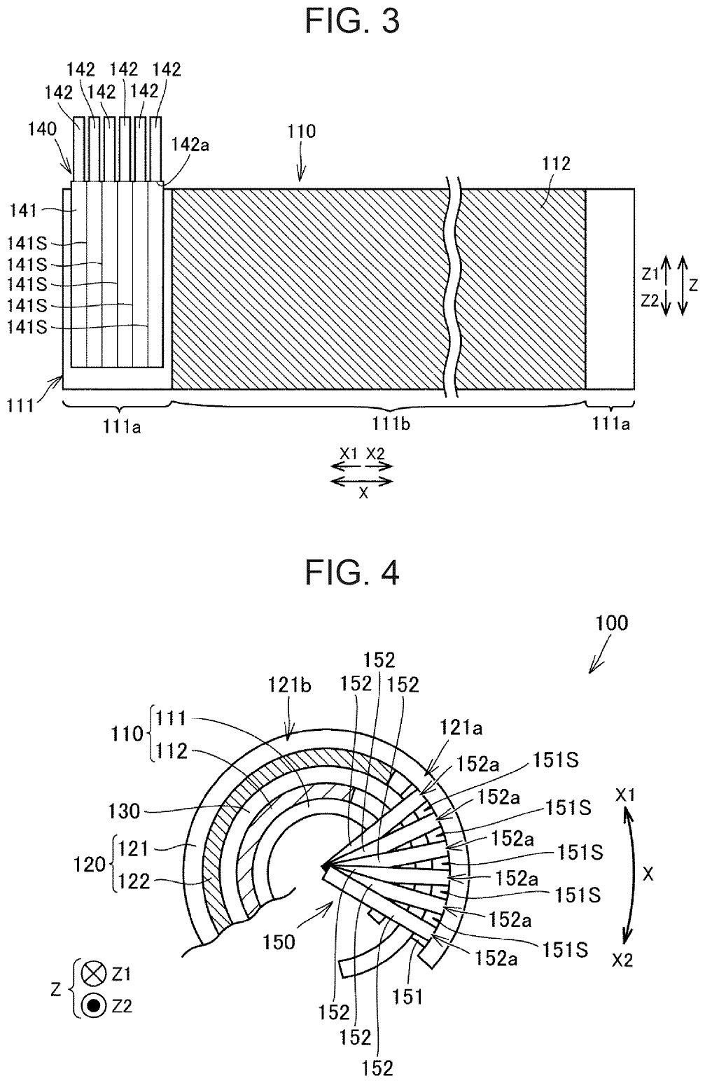

FIG. 2 is a schematic plan view of a portion of the wound electrode body as viewed from one side in an axial direction of the wound electrode body. FIG. 3 is a schematic diagram showing the positive electrode plate and the positive electrode tab lead in a state where they are unwound and extended in a planar shape.

As shown in FIGS. 2 and 3, the positive electrode plate 110 includes a positive current collector foil 111 and a positive electrode material layer 112. The positive electrode material layer 112 covers a part of the positive electrode current collector foil 111.

The positive electrode current collector foil 111 has an uncoated portion 111a and a coated portion 111b. The uncoated portion 111a is a portion of the positive electrode current collector foil 111 that is not coated with the positive electrode material layer 112. The coated portion 111b is a portion of the positive electrode current collector foil 111 that is coated with the positive electrode material layer 112.

In the present embodiment, the uncoated portion 111a is provided at each of end portions on an X1 side and an X2 side of the positive electrode plate 110. The X1 side is a winding end side of the wound electrode body 100 in the winding direction X. The X2 side is a winding start side in the winding direction X. In other words, the X1 side is an outer peripheral side of the wound electrode body 100 in a radial direction R, and the X2 side is a center side of the wound electrode body 100 in the radial direction R.

In the positive electrode plate 110 of the present embodiment, one coated portion 111b is provided so as to be continuous in the winding direction X. In other words, in the positive electrode plate 110, one positive electrode material layer 112 is provided so as to be continuous in the winding direction X. However, a plurality of coated portions 111b may be provided so as to be spaced apart from one another in the winding direction X. In other words, a plurality of positive electrode material layers 112 may be provided so as to be spaced apart from one another in the winding direction X. The uncoated portions 111a may be arranged between the plurality of coated portions 111b in the winding direction X.

For example, aluminum is used for the positive electrode current collector foil 111. The positive electrode material layer 112 is formed by applying a positive electrode slurry on the surface of the positive electrode current collector foil 111 and then drying it. The positive electrode slurry is a slurry prepared by kneading a positive electrode active material, a binder, and the like with a solvent. The positive electrode material layer 112 is in close contact with the separator 130. The thickness of the positive electrode material layer 112 is, for example, equal to 0.1 μm or more and 1000 μm or less.

Note that the positive electrode plate 110, the positive current collector foil 111, and the positive electrode material layer 112 may be examples of the “electrode plate”, the “current collector foil”, and the “electrode material layer” of the present disclosure, respectively.

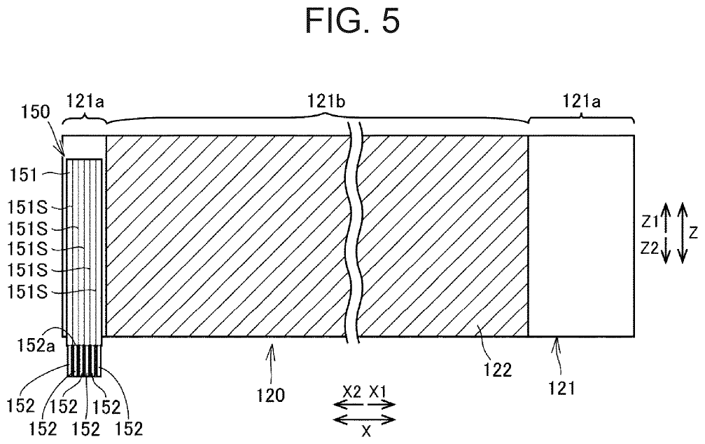

FIG. 4 is a schematic plan view of a portion of the wound electrode body as viewed from the other side in the axial direction of the wound electrode body. FIG. 5 is a schematic diagram showing the negative electrode plate and the negative electrode tab lead in a state where they are unwound and extended in a planar shape.

As shown in FIGS. 4 and 5, the negative electrode plate 120 includes a negative electrode current collector foil 121, and a negative electrode material layer 122. The negative electrode material layer 122 covers a part of the negative electrode current collector foil 121.

The negative electrode current collector foil 121 has an uncoated portion 121a and a coated portion 121b. The uncoated portion 121a is a portion of the negative electrode current collector foil 121 that is not coated with the negative electrode material layer 122. The coated portion 121b is a portion of the negative electrode current collector foil 121 that is coated with the negative electrode material layer 122.

In the present embodiment, the uncoated portion 121a is provided at each of end portions on an X1 side and an X2 side of the negative electrode plate 120.

In the negative electrode plate 120 of the present embodiment, one coated portion 121b is provided so as to be continuous in the winding direction X. In other words, in the negative electrode plate 120, one negative electrode material layer 122 is provided so as to be continuous in the winding direction X. However, a plurality of coated portions 121b may be provided so as to be spaced apart from one another in the winding direction X. In other words, a plurality of negative electrode material layers 122 may be provided so as to be spaced apart from one another in the winding direction X. The uncoated portions 121a may be arranged between the plurality of coated portions 121b in the winding direction X.

For example, copper is used for the negative electrode current collector foil 121. The negative electrode material layer 122 is formed by applying a negative electrode slurry onto the surface of the negative electrode current collector foil 121 and then drying it. The negative electrode slurry is a slurry prepared by kneading a negative electrode active material, a binder, and the like with a solvent. The negative electrode material layer 122 is in close contact with the separator 130. The thickness of the negative electrode material layer 122 is, for example, equal to 0.1 μm or more and 1000 μm or less.

Note that the negative electrode plate 120, the negative electrode current collector foil 121, and the negative electrode material layer 122 may be other examples of the “electrode plate”, “current collector foil”, and “electrode material layer” of the present disclosure, respectively.

As shown in FIGS. 1, 2, and 4, the separator 130 is provided between the positive electrode plate 110 and the negative electrode plate 120. The separator 130 separates the positive electrode plate 110 and the negative electrode plate 120 from each other while allowing ions (for example, lithium ions) to pass between the positive electrode material layer 112 of the positive electrode plate 110 and the negative electrode material layer 122 of the negative electrode plate 120.

As shown in FIGS. 1 to 3, the positive electrode tab lead 140 is provided so as to protrude from the positive current collector foil 111 of the positive electrode plate 110 to one side (Z1 side) in an axial direction Z. The positive electrode tab lead 140 includes a curved portion 141 and extending portions 142.

The curved portion 141 is provided on the uncoated portion 111a. The curved portion 141 is provided on the uncoated portion 111a located at the end portion on the X1 side of the positive electrode plate 110. However, the curved portion 141 may be provided on the uncoated portion 111a located at the end portion on the X2 side of the positive electrode plate 110. When the uncoated portion 111a is not located at the end portion of the positive electrode plate 110 in the winding direction X, the curved portion 141 may be provided on such an uncoated portion 111a. The curved portion 141 extends so as to curve along the winding direction X of the wound electrode body 100.

In the present embodiment, the curved portion 141 protrudes to one side (Z1 side) of the positive electrode current collector foil 111 in the axial direction Z of the wound electrode body 100, which makes it easier for the extending portions 142 to bend at root portions 142a of the extending portions 142. Note that the entire curved portion 141 may be provided on the uncoated portion 111a.

The curved portion 141 has a groove portion 141S. The groove portion 141S extends along the axial direction Z. The curved portion 141 has a plurality of groove portions 141S. The plurality of groove portions 141S are arranged side by side in the winding direction X. The plurality of groove portions 141S are arranged at approximately equal intervals in the winding direction X. Each groove portion 141S extends from one end edge of the curved portion 141 in the axial direction Z to the other end edge. Each groove portion 141S extends linearly along the axial direction Z.

The extending portions 142 extend from the curved portion 141. The curved portion 141 protrudes to one side (Z1 side) of the positive electrode current collector foil 111 in the axial direction Z of the wound electrode body 100.

The extending portion 142 has a root portion 142a. The root portion 142a is a portion connected to the curved portion 141. The root portions 142a are arranged so as not to be lined up with the groove portions 141S in the axial direction Z.

The extending portions 142 are bent at the root portions 142a. The extending portions 142 are bent toward the center side in the radial direction R of the wound electrode body 100.

The positive electrode tab lead 140 has a plurality of extending portions 142. The plurality of extending portions 142 are arranged side by side in the winding direction X. Each of the plurality of extending portions 142 has a root portion 142a that is a portion connected to the curved portion 141. The root portion 142a of each of the plurality of extending portions 142 is arranged so as not to be lined up with the groove portion 141S in the axial direction Z. Specifically, each root portion 142a is arranged so as not to be lined up with any of the plurality of groove portions 141S in the axial direction Z. The respective root portions 142a of the plurality of extending portions 142 are spaced apart from one another in the winding direction X.

The plurality of extending portions 142 are bent at the root portions 142a of the respective extending portions 142. The plurality of extending portions 142 are bent toward the center side in the radial direction R of the wound electrode body 100. When viewed in the axial direction Z, the plurality of extending portions 142 overlap one another. The plurality of extending portions 142 may be welded to one another.

As shown in FIGS. 1, 4, and 5, the negative electrode tab lead 150 is provided so as to protrude from the negative electrode current collector foil 121 of the negative electrode plate 120 to the other side (Z2 side) in the axial direction Z. The negative electrode tab lead 150 includes a curved portion 151 and extending portions 152.

The curved portion 151 is provided on the uncoated portion 111a. The curved portion 151 is provided on the uncoated portion 121a located at an end portion on the X2 side of the negative electrode plate 120. However, the curved portion 151 may be provided on the uncoated portion 121a located at an end portion on the X1 side of the negative electrode plate 120. When the uncoated portion 121a is not located at the end portion of the negative electrode plate 120 in the winding direction X, the curved portion 151 may be provided on such an uncoated portion 121a. The curved portion 151 extends so as to be curved along the winding direction X.

In the present embodiment, the curved portion 151 protrudes to the other side (Z2 side) of the negative electrode current collector foil 121 in the axial direction Z of the wound electrode body 100, which makes it easier for the extending portions 152 to be bent at the root portions 152a of the extending portions 152. Note that the entire curved portion 151 may be provided on the uncoated portion 111a.

The curved portion 151 has a groove portion 151S. The groove portion 151S extends along the axial direction Z. The curved portion 151 has a plurality of groove portions 151S. The plurality of groove portions 151S are arranged side by side in the winding direction X. The plurality of groove portions 151S are arranged at approximately equal intervals in the winding direction X. Each groove portion 151S extends from one end edge of the curved portion 151 in the axial direction Z to the other end edge of the curved portion 151. Each groove portion 151S extends linearly along the axial direction Z.

The extending portions 152 extend from the curved portion 151. The extending portions 152 extend to the other side (Z2 side) of the negative electrode current collector foil 121 in the axial direction Z of the wound electrode body 100.

The extending portion 152 has a root portion 152a. The root portion 152a is a portion connected to the curved portion 151. The root portions 152a are arranged so as not to be lined up with the groove portions 151S in the axial direction Z.

The extending portions 152 are bent at the root portions 152a of the extending portions 152. The extending portions 152 are bent toward the center side in the radial direction R of the wound electrode body 100.

The negative electrode tab lead 150 has a plurality of extending portions 152. The plurality of extending portions 152 are arranged side by side in the winding direction X. Each of the plurality of extending portions 152 has a root portion 152a that is a portion connected to the curved portion 151. The respective root portions 152a of the plurality of extending portions 152 are arranged so as not to be lined up with the groove portions 151S in the axial direction Z. Specifically, each root portion 152a is arranged so as not to be lined up with any of the plurality of groove portions 151S in the axial direction Z. The respective root portions 152a of the plurality of extending portions 152 are spaced apart from one another in the winding direction X.

The plurality of extending portions 152 are bent at the root portions 152a of the respective extending portions 152. The plurality of extending portions 152 are bent toward the center side in the radial direction R of the wound electrode body 100. When viewed in the axial direction Z, the plurality of extending portions 152 overlap one another. The plurality of extending portions 152 may be welded to one another.

As shown in FIG. 1, the cell case 200 accommodates the wound electrode body 100. The cell case 200 has a cylindrical outer shape. Therefore, the storage cell 1 is a cylindrical battery.

The cell case 200 has an outer peripheral wall portion 210, a first end portion 220, and a second end portion 230.

The outer peripheral wall portion 210 has a cylindrical shape, and is disposed on the outside of the wound electrode body 100 in the radial direction R. The outer peripheral wall portion 210 is made of copper, aluminum, or the like. The outer peripheral wall portion 210 is in contact with the negative electrode current collector of the negative electrode plate 120 provided on the outermost periphery of the wound electrode body 100.

The first end portion 220 is connected to one side (Z1 side) of the outer peripheral wall portion 210 in the axial direction Z of the wound electrode body 100.

A Specifically, the first end portion 220 includes an external cap 222, an insulating layer 223, and a crimping portion 224.

The external cap 222 is electrically connected to an external bus bar (not shown), which brings the external cap 222 with a function as an external terminal. The external cap 222 is provided with a fragile portion 225 (thin portion). The external cap 222 is easily broken with the fragile portion 225 as a start point of the breaking when the internal pressure of the cell case 200 increases. As a result, gas is quickly discharged to the outside of the cell case 200. The external cap 222 is made of copper, aluminum, or the like.

The insulating layer 223 is arranged so as to cover the outer peripheral end of the external cap 222. The insulating layer 223 is provided so as to insulate the external cap 222 and the crimping portion 224 from each other.

The crimping portion 224 is connected to one side of the outer peripheral wall portion 210 in the axial direction Z of the wound electrode body 100. The crimping portion 224 is formed integrally with the outer peripheral wall portion 210. The crimping portion 224 crimps the outer peripheral edge of the external cap 222 (and a conductive film 510 described later) through the insulating layer 223. The crimping portion 224 is made of copper, aluminum or the like.

The second end portion 230 is connected to the other side (Z2 side) of the outer peripheral wall portion 210 in the axial direction Z. The second end portion 230 has a disc-like outer shape. The second end portion 230 is made of copper, aluminum, or the like. A peripheral edge of the second end portion 230 is connected to the outer peripheral wall portion 210. The second end portion 230 is formed integrally with the outer peripheral wall portion 210.

The second end portion 230 is in contact with the negative electrode tab lead 150. As a result, the negative electrode tab lead 150 and the second end portion 230 are electrically connected to each other. As a result, the second end portion 230, the outer peripheral wall portion 210 connected to the second end portion 230, and the crimping portion 224 are negatively charged.

The storage cell 1 further includes a positive side insulating plate 300, a negative side insulating plate 400, and a current interrupt device (CID) 500.

The positive side insulating plate 300 is accommodated in the cell case 200. The positive side insulating plate 300 is provided so as to insulate the wound electrode body 100 (the negative electrode plate 120 and the separator 130) and the cell case 200 from each other. The positive side insulating plate 300 is provided so as to cover the positive electrode plate 110, the negative electrode plate 120, and the separator 130 from one side (Z1 side).

The positive side insulating plate 300 has a first through hole 310. The extending portions 142 of the positive electrode tab lead 140 are inserted into the first through hole 310 to be in contact with the conductive film 510 described later, so that the positive electrode tab lead 140 and the conductive film 510 are electrically connected to each other.

The negative side insulating plate 400 is accommodated in the cell case 200. The negative side insulating plate 400 is provided so as to insulate the wound electrode body 100 (the positive electrode plate 110 and the separator 130) and the cell case 200 from each other. The negative side insulating plate 400 is provided so as to cover the positive electrode plate 110, the negative electrode plate 120, and the separator 130 from the other side (Z2 side).

The negative side insulating plate 400 has a second through hole 410. The extending portions 152 of the negative electrode tab lead 150 are inserted into the second through hole 410, whereby the extending portions 152 of the negative electrode tab lead 150 and the second end portion 230 are electrically connected to each other.

The CID 500 is an element for blocking a current path by utilizing an increase in cell internal pressure caused by gas generated due to overcharging of the storage cell 1. The CID 500 is provided so as to seal an opening on one side (Z1 side) of the outer peripheral wall portion 210. The CID 500 includes the conductive film 510, a gasket 520, and a bottom disk 530.

The conductive film 510 is provided so as to seal the opening on the one side (Z1 side) of the outer peripheral wall portion 210. The conductive film 510 is in contact with the extending portions 142 of the positive electrode tab lead 140. As a result, the conductive film 510 is positively charged. Further, the conductive film 510 is electrically connected to the external cap 222 by a connecting member (not shown). As a result, the external cap 222 is also positively charged.

Specifically, the conductive film 510 includes a protruding portion 511 that protrudes toward the wound electrode body 100 side (Z2 side). The protruding portion 511 is in contact with the extending portions 142 of the positive electrode tab lead 140.

The conductive film 510 is provided with a fragile portion 512 (thin portion) similarly to the external cap 222. The conductive film 510 is easily broken with the fragile portion 512 as a starting point of the breaking when the internal pressure of the cell case 200 increases. When the conductive film 510 is broken due to an increase in internal pressure of the conductive film 510, the contact between the conductive film 510 and the extending portions 142 of the positive electrode tab lead 140 is released. As a result, the positive charge on the conductive film 510 is eliminated, and the positive charge on the external cap 222 is also eliminated. As a result, charging and discharging of the storage cell 1 are stopped.

The gasket 520 is located on the wound electrode body 100 side of the conductive film 510. The bottom disk 530 is connected to the conductive film 510 through the gasket 520. The protruding portion 511 of the conductive film 510 penetrates through the gasket 520 and the bottom disk 530.

As described above, in the storage cell 1 according to the embodiment of the present disclosure, the curved portion 141 of the positive electrode tab lead 140 has the groove portions 141S. As a result, the curved portion 141 is easily bent at the groove portions 141S. Accordingly, even when the positive electrode tab lead 140 is made larger in the winding direction X, the curved portion 141 can extend in a direction closer to the winding direction X. As a result, stress on the positive electrode tab lead 140 can be reduced.

Furthermore, in the negative electrode tab lead 150 as well, the curved portion 151 has the groove portions 151S. As a result, the curved portion 151 is easily bent at the groove portions 151S. Therefore, even when the negative electrode tab lead 150 is made larger in the winding direction X, the curved portion 151 can extend in a direction closer to the winding direction X. As a result, stress on the negative electrode tab lead 150 can be reduced.

The embodiment disclosed at this time should be considered to be illustrative in all respects, and not to be restrictive. The scope of the present disclosure is indicated by the claims rather than the description of the embodiment described above, and it is intended that all changes within the meaning and range equivalent to the claims are included.

What is claimed is:

1. A storage cell comprising:
a wound electrode body; and
a cell case that accommodates the wound electrode body, wherein:
the wound electrode body includes an electrode plate and a tab lead;
the electrode plate includes a current collector foil, and an electrode material layer covering a part of the current collector foil;
the tab lead includes a curved portion that is provided on an uncoated portion of the current collector foil that is not coated with the electrode material layer, and extends so as to be curved along a winding direction of the wound electrode body, and an extending portion that extends from the curved portion and protrudes to one side of the current collector foil in an axial direction of the wound electrode body; and
the curved portion includes a groove portion extending along the axial direction.

2. The storage cell according to claim 1, wherein the curved portion includes a plurality of groove portions arranged side by side in the winding direction.

3. The storage cell according to claim 1, wherein the extending portion has a root portion that is a portion connected to the curved portion, and the root portion is arranged so as not to be lined up with the groove portion in the axial direction.

4. The storage cell according to claim 1, wherein the tab lead has a plurality of extending portions arranged side by side in the winding direction, each of the plurality of extending portions has a root portion that is a portion connected to the curved portion, and the root portion of each of the plurality of extending portions is arranged so as not to be lined up with the groove portion in the axial direction.

5. The storage cell according to claim 2, wherein the tab lead has a plurality of extending portions arranged side by side in the winding direction, each of the plurality of extending portions has a root portion that is a portion connected to the curved portion, the root portion of each of the plurality of extending portions is arranged so as not to be lined up with any of the plurality of groove portions in the axial direction, and the respective root portions of the plurality of extending portions are spaced apart from one another in the winding direction.
